(19) United States
(12) Patent Application Publication
(10) Pub. No.: US 2024/0428283 A1
(43) Pub. Date: Dec. 26, 2024

(54) SYSTEMS AND METHODS FOR OPTIMAL RENEWALS VERIFICATIONS USING MACHINE LEARNING MODELS

(71) Applicant: THE TORONTO-DOMINION BANK, Toronto (CA)

(72) Inventors: MOULOUD-BEALLAH BELBAHRI, LAVAL (CA); OLIVER HUGUES BENOIT GANDOUET, MONTREAL (CA); DALIA FARAG, POINTE-CLAIRE (CA); WYSSEM DOUMANDJI, BOUCHERVILLE (CA); JUSTIN DAGENAIS, PRÈVOST (CA); VLADISLAV GANTMAN, MONTREAL (CA); YUET YING DOROTHY FONG, TORONTO (CA)

(21) Appl. No.: 18/747,732

(22) Filed: Jun. 19, 2024

Related U.S. Application Data
(60) Provisional application No. 63/522,092, filed on Jun. 20, 2023.

(51) Int. Cl. G06Q 30/0207; G06N 20/00

(52) U.S. Cl. CPC G06Q 30/0207; G06N 20/00

(57) ABSTRACT

Systems and methods are provided for obtaining, from a database, a set of unlabeled data comprising data entries for a plurality of clients relating to eligibility for particular category of product, service or resource, e.g. discounted rates, applying a selection model to the set of unlabeled data to obtain a subset of unlabeled data, sending, to the communication interface, the subset of unlabeled data for oracle review by an oracle, receiving, from the communication interface, a subset of labeled data comprising a label from the oracle regarding eligibility for discounted rates of each of the plurality of clients in the subset of unlabeled data, applying, in a training phase, the subset of labeled client to a prediction model to adjust parameters of the prediction model, the prediction model for predicting whether each of the plurality of clients in the unlabeled data is eligible for discounted rates.

### CROSS-REFERENCE TO RELATED APPLICATION

This application claims the benefit of U.S. Provisional Patent Application No. 63/522,092, filed Jun. 20, 2023, and entitled “Systems and Methods for Optimal Renewals Verifications Using Machine Learning Models”, the entire contents of which is incorporated by reference herein in its entirety.

### FIELD

The present disclosure relates to systems and methods for predicting eligibility for discounted rates on renewal using machine learning framework and in particular, systems and methods using active learning applied to machine learning framework in sampling data for training and tuning.

### BACKGROUND

In some industries, clients may have access to rebates. As these rebates are dynamic, eligibility and applicability may change over time. Verification of a client's continued eligibility for a particular category of service such as discounted rate for a product or service upon renewal may be important to ensure the proper categories are applied.

Currently, this verification process may be performed by human workers and may involve contacting the client to confirm or obtain information. With a new verification process, if a client is found to be no longer eligible to the group rate, the client will be contacted, and the policy will be re-rated at renewal. As such process may be time and labour intensive, a computing model for predicting whether an application is eligible may useful.

Generally, prediction models built with limited useful data face significant challenges, including overfitting, where models learn noise rather than patterns, and underfitting, where models remain too simplistic. They often exhibit bias, failing to represent real-world diversity, and high variance, where predictions are overly sensitive to specific training data points. Limited data may lead to reduced feature exploration, higher generalization error, and difficulties in robust validation.

### SUMMARY

The effectiveness of machine learning models is largely dependent on the availability of relevant labeled data. In applications without existing labeled data related to the renewal process, there is no past data for already verified clients, e.g. whether they were eligible, and whether their policy had been re-rated at renewal. Therefore, labeled data is required to be generated. To build relevant labeled data over time using human generated data would require a lengthy period of collection time. During such collection time, the model may be of limited use as such model would have necessary data for training and/or testing. There is a need for machine learning models in renewal applications without the availability of a significant amount of existing labelled data for renewals.

There is a need for improved computerized systems and methods to dynamically predict, in real-time and based on continually changing input data communicated across a computing network whether clients or end users are likely to be eligible for particular resources or services, e.g. discounted rates in order to reduce and/or eliminate manual input and verification and associated costs by flagging to more likely re-rate cases. This may be accomplished by identifying, at least in part, those clients which may be most likely to be re-rated. In some embodiments of the present disclosure, a machine learning predictive model may be used. To address technical issues relating to the availability of labeled data which limits use in machine learning applications, which is further relevant in the renewal context in which client information may only be obtained and updated once per year, an active learning selection or query computerized model may be used to more effectively select data to train the predictive model.

An active learning selection or query model maybe considered an optimized sampling method, which may rely upon a specific model, and identifies the most promising data points to sample in order to improved performance of the predictive model. In some examples, human or oracle assistance being where a human or computational resource outside the predictive model is used to provide, verify or confirm results from the machine learning systems and methods.

In one or more aspects, computing systems and methods for predictive data analytics and verification are described to improve existing computing models.

In one general aspect, there is disclosed herein a computer implemented system comprising: a computer implemented system comprising: a communication interface; a memory storing instructions; one or more processors coupled to the communications interface and to the memory, the one or more processors configured to execute the instructions to perform operations to train a prediction model using active learning comprising: obtaining, from a database, a set of unlabeled data comprising a set of first data entries for a plurality of clients relating to eligibility for discounted rates; applying a selection model to the set of unlabeled data to obtain a subset of unlabeled data, wherein the subset of unlabeled data is for investigation by an oracle; sending, to the communication interface, the subset of unlabeled data for investigation by the oracle; receiving, from the communication interface, a set of labeled data comprising second data entries corresponding to the clients in the subset of unlabeled data, each of the second data entries comprising a label from the oracle indicating whether each client of the plurality of clients is eligible for discounted rates; applying, in a training phase, the subset of labeled data to the prediction model to adjust parameters of the prediction model, the prediction model for predicting whether an input client would be eligible for discounted rates.

In a further aspect, the selection model comprises an exploration weighting, wherein the exploration weighting is for determining the preference of selecting unlabeled data that the prediction model is not trained for.

In a further aspect, the selection model comprises a challenger weighting, wherein the challenger weighting is for determining the preference of randomly selecting unlabeled data.

In a further aspect, the selection model comprises an exploitation weighting, wherein the exploitation weighting is for determining the preference of selecting unlabeled data that is likely not eligible for discounted rates.

In a further aspect, the operations further comprise applying the prediction model to the set of unlabeled data to a set of predictions, wherein the set of predictions comprises a prediction of discounted rate eligibility for each of the plurality of clients.

In a further aspect, the operations further comprise providing a reward score of the prediction model, wherein the reward score is the number of clients in the plurality of clients that require a re rate based on an associated discounted rate eligibility.

In a further aspect, the set of unlabeled data is for renewals within a renewal period.

In a further aspect, the operations further comprise removing first data entries in the set of unlabeled data for clients over a threshold age.

In a further aspect, the operations further comprise receiving an affinity list from the database and searching the first data entries for clients in the affinity list, wherein any first data entries for clients in the affinity list are removed from the set of unlabeled data.

In a further aspect, the operations further comprise receiving a member list from the database and searching the first data entries for clients in the member list, wherein any first data entries for clients in the member list are removed from the set of unlabeled data.

In one general aspect, a computer implemented method comprises: obtaining, from a database, a set of unlabeled data comprising a set of first data entries for a plurality of clients relating to eligibility for discounted rates; applying a selection model to the set of unlabeled data to obtain a subset of unlabeled data, wherein the subset of unlabeled data is for investigation by an oracle; sending, to the communication interface, the subset of unlabeled data for investigation by the oracle; receiving, from the communication interface, a set of labeled data comprising second data entries corresponding to the clients in the subset of unlabeled data, each of the second data entries comprising a label from the oracle indicating whether each client of the plurality of clients is eligible for discounted rates; applying, in a training phase for training a prediction model using active learning, the subset of labeled data to the prediction model to adjust parameters of the prediction model, the prediction model for predicting whether an input client would be eligible for discounted rates.

In a further aspect, the selection model comprises an exploration weighting, wherein the exploration weighting is for determining the preference of selecting unlabeled data that the prediction model is not trained for.

In a further aspect, the selection model comprises a challenger weighting, wherein the challenger weighting is for determining the preference of randomly selecting unlabeled data.

In a further aspect, the selection model comprises an exploitation weighting, wherein the exploitation weighting is for determining the preference of selecting unlabeled data that is likely not eligible for discounted rates.

In a further aspect, the method further comprises applying the prediction model to the set of unlabeled data to a set of predictions, wherein the set of predictions comprises a prediction of discounted rate eligibility for each of the plurality of clients.

In a further aspect, the method further comprises providing a reward score of the prediction model, wherein the reward score is the number of clients in the plurality of clients that require a re rate based on an associated discounted rate eligibility.

In a further aspect, the set of unlabeled data is for renewals within a renewal period.

In a further aspect, the method further comprises removing first data entries in the set of unlabeled data for clients over a threshold age.

In a further aspect, the method further comprises receiving an affinity list from the database and searching the first data entries for clients in the affinity list, wherein any first data entries for clients in the affinity list are removed from the set of unlabeled data.

In a further aspect, the method further comprises receiving a member list from the database and searching the first data entries for clients in the member list, wherein any first data entries for clients in the member list are removed from the set of unlabeled data.

### BRIEF DESCRIPTION OF THE DRAWINGS

These and other features will become more apparent from the following description in which reference is made to the appended drawings wherein:

FIG. 1 is a diagram of an exemplary computing environment for utilizing machine learning framework for predicted discounted rate eligibility in accordance with or more embodiments disclosed herein.

FIG. 2 is a diagram of an exemplary computing system, a prediction model of FIG. 1 in accordance with one or more embodiments disclosed herein.

FIG. 3 is a graph illustrating an exemplary learning curve of model accuracy as a function of an amount of labeled data for a smart selection in accordance with one or more embodiments disclosed herein against a random selection.

FIG. 4A is a flowchart illustrating an exemplary workflow of an embodiment of a selection model (e.g. as may be used in FIG. 1) in accordance with one or more embodiments disclosed herein.

FIG. 4B is a flowchart illustrating an exemplary workflow active learning loop of an embodiment of a selection model (e.g. as may be used in FIG. 1 and FIG. 4A) in accordance with one or more embodiments disclosed herein.

FIG. 5 is a diagram showing an exemplary embodiment of an artificial neural network in accordance with one or more embodiments disclosed herein.

FIG. 6 is a flowchart illustrating an exemplary workflow of an embodiment of a method in accordance with one or more embodiments disclosed herein.

FIG. 7 is a flowchart illustrating an exemplary workflow of an embodiment of a method in accordance with one or more embodiments disclosed herein.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

The term “a” or “an” refers to one or more of that entity; for example, “a device” refers to one or more device or at least one device. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., devices), unless clearly intended, does not mean that the systems or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

Generally, in at least some embodiments of the present disclosure, computerized systems and methods are provided for communicating in a computing environment for predicting eligibility of existing clients and input applications for a particular category of resource, service or product, e.g. eligibility of discounted rates of a product or service upon renewal of the application. Predictive models may require a significant amount of labeled data to develop or learn a useful prediction model and labeling data may be time-consuming and/or expensive. In some embodiments disclosed herein, active learning framework is applied to the computing system to address the shortcomings of the data and the predictive models, wherein active learning may be a machine learning optimal sampling method, which relies on a specific model, and identifies promising data points to sample in order to improve model performance. In one or more examples, the active learning is a subset of machine learning whereby the learning algorithm may query external sources interactively to label data. Conveniently, by applying active learning this makes it possible to start with a weak predictive model built on a small, labelled dataset, and allows it to improve over time. Machine learning methods are capable of achieving better performance if the learning method is involved in the process of selecting the data points it is trained on. In one or more aspects, the machine learning methods used herein for the learning models may be based upon random forest models.

As will be described herein, one of the technical problems in developing a machine learning model or other prediction model to accurately predict discounted rate eligibility is where there is a lack of available labeled data to learn from. As labeling data may be time consuming, unfeasible and prohibitive in some instances, these data challenges may lead to computing challenges in accurately predicting an output value, e.g. discounted rate eligibility. Although described in examples herein, the models are described with respect to the context of predicting renewals eligibility or discounted rate eligibility, other types of predictions may be envisaged in other example implementations whereby there is limited or non-existent labelled data or no past data specifying prior results and predictions thereby limiting efficacy of typical prediction models.

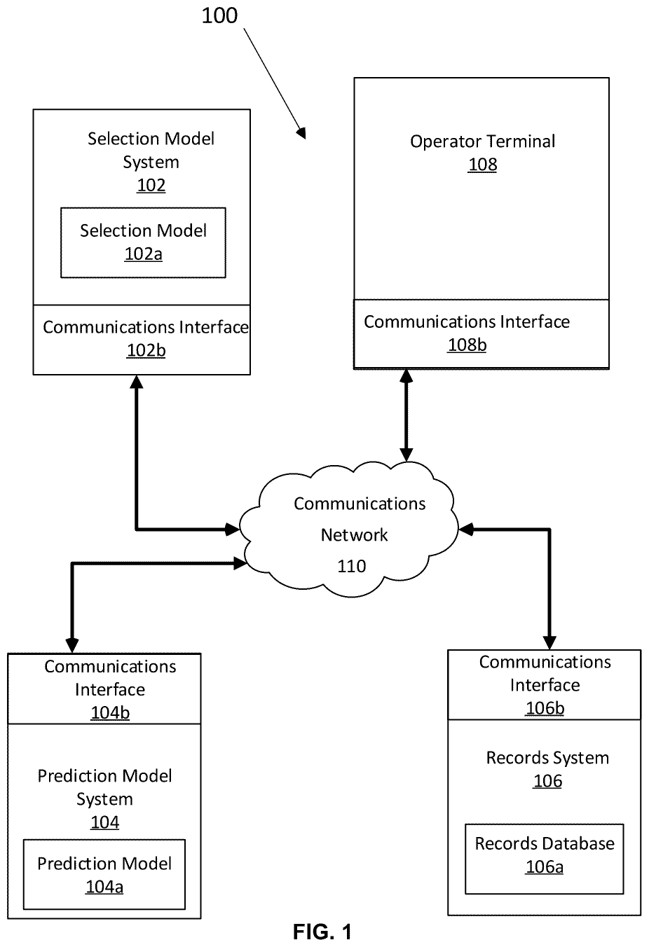

FIG. 1 illustrates an exemplary computing environment 100 in accordance with one or more embodiments. As illustrated in FIG. 1, in one aspect, the computing environment may include a prediction model system 104, a selection model system 102, a records system 106, and an operator terminal 108.

Referring again to FIG. 1, the prediction model system 104 may be configured to use one or more machine learning prediction models 104a to predict discounted rate eligibility of clients upon renewal. The prediction model system 104 may include a core machine learning model or models designed to analyze and predict eligibility as described herein and to handle the data limitations of the training/tuning data sets as well as the diversity in the data types which may be received. In one embodiment, the prediction model system 104 may be one or more computer systems configured to process and store information and execute software instructions to perform one or more processes consistent with the disclosed embodiments. In certain embodiments, the prediction model system 104 may include one or more servers and one or more data storages. Further, in some embodiments, the prediction model system 104 may comprise a communication interface 104b for communicating with other systems or devices on a communications network 110.

The selection model system 102 may be configured to use active learning and machine learning to assist in training the prediction model 104a. An active learning selection or query model maybe considered an optimized sampling method, which may rely upon a specific model, and identifies the most promising data points to sample in order to improve performance of the predictive model. Human or oracle assistance may be used, in some examples, in active learning where a human or computational resource outside a predictive model is used to provide or confirm results related to the prediction.

The selection model system 102 may include a core machine learning or selection model or models 102a designed to select data for active as described herein and to handle the data limitations of the training/tuning data sets as well as the diversity in the data types which may be received. In one embodiment, the selection model system 102 may be one or more computer systems configured to process and store information and execute software instructions to perform one or more processes consistent with the disclosed embodiments. In certain embodiments, the selection model system 102 may include one or more servers and one or more data storages. Further, in some embodiments, the selection model system 102 may comprise a communication interface 102b for communicating with other systems or devices on a communications network 110.

The records system 106 may comprise records databases 106a relating to clients as well as lists and groups, which may be used to filter, verify or disqualify clients for certain discounts or rebates. In one embodiment, the records system 106 may be one or more computer systems configured to process and store information and execute software instructions to perform one or more processes consistent with the disclosed embodiments. In certain embodiments, the records system 106 may include one or more servers and one or more data storages. Further, in some embodiments, the records system 106 may comprise a communication interface 106b for communicating with other systems or devices on a communications network 110.

The operator terminal 108 may serve as a computerized interface or platform utilized by human users or oracles to input, access, verify and review and/or label data as may be transacted across the computing environment 100. In one embodiment, the operator terminal 108 may be one or more computer systems configured to process and store information and execute software instructions to perform one or more processes consistent with the disclosed embodiments. In certain embodiments, the operator terminal 108 may include one or more servers and one or more data storages. Further, in some embodiments, the operator terminal 108 may comprise a communication interface 108b for communicating with other systems or devices on a communications network 110.

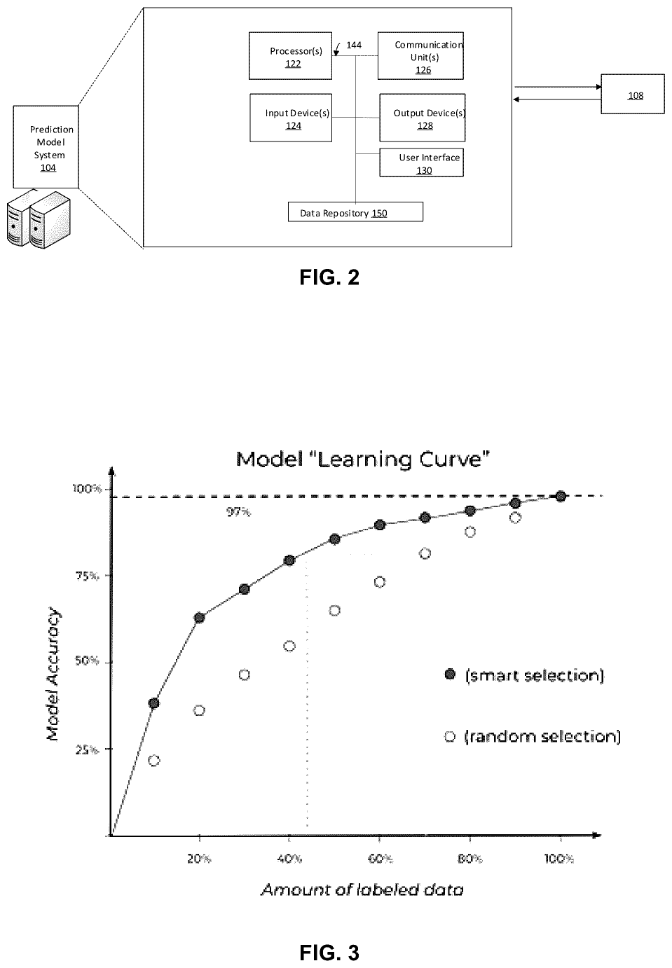

Referring to FIG. 2, shown is an example computer system, e.g. prediction model system 104, with which embodiments consistent with the present disclosure may be implemented. The prediction model system 104 includes at least one processor 122 (such as a microprocessor) which controls the operation of the computer. The processor 122 is coupled to a plurality of data storage components and computing components via a communication bus or channel, shown as the communication channel 144.

The prediction model system 104 further comprises one or more input devices 124, one or more communication units or communication interfaces 102b such as for communicating with over the communication network 110.

Communication channels 144 may couple each of the components for inter-component communications whether communicatively, physically and/or operatively. In some examples, communication channels 144 may include a system bus, a network connection, an inter-process communication data structure, or any other method for communicating data.

Referring to FIG. 1 and FIG. 2, one or more processors 122 may implement functionality and/or execute instructions as provided in the current disclosure within the prediction model system 104. The processor 122 is coupled to a plurality of computing components via the communication bus or communication channel 144 which provides a communication path between the components and the processor(s) 122. For example, processors 122 may be configured to receive instructions and/or data from storage devices to execute the functionality of the modules shown in FIG. 2.

One or more communication units and associated communications interfaces 104b may communicate with external devices by transmitting and/or receiving network signals on the one or more communications networks 110. The communication interfaces 120b may be implemented through one or more communications units 126, which may include various antennae and/or network interface cards, etc. for wireless and/or wired communications.

Input devices 124 and output devices 128 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 144). The output device 128 may be for displaying a user interface 130, such as for displaying results from the prediction model system 104 and/or allowing interactive input on the user interface, such as via an operator terminal 108.

The one or more data repositories 150 may store instructions and/or data for processing during operation of the policy processing system. The one or more storage devices may take different forms and/or configurations, for example, as short-term memory or long-term memory. Data repositories 150 may be configured for short-term storage of information as volatile memory, which does not retain stored contents when power is removed. Volatile memory examples include random access memory (RAM), dynamic random-access memory (DRAM), static random access memory (SRAM), etc. Data repositories 150, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

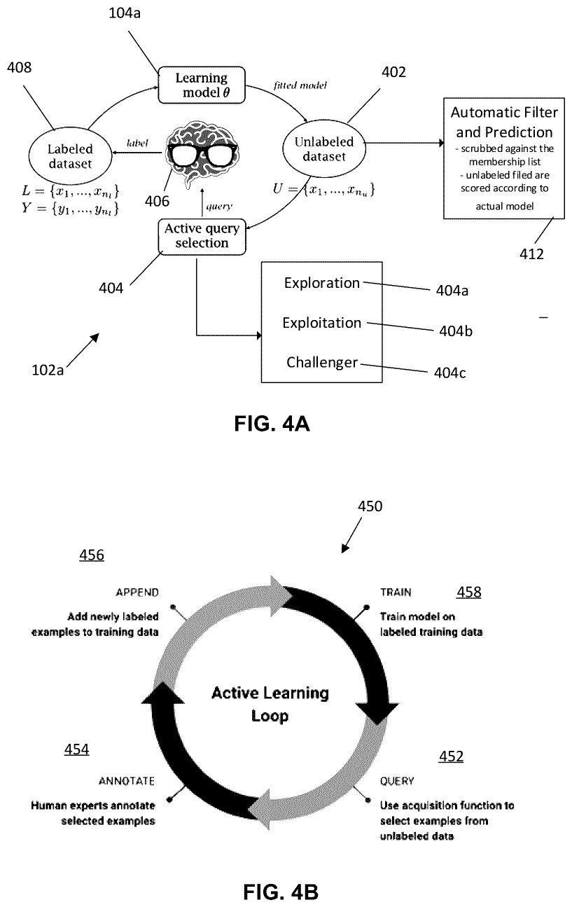

FIG. 4A illustrates an exemplary workflow of some embodiments of a selection model comprising an unlabeled dataset 402 going through active query selection 404, the active query selection comprising weightings for exploration 404a, exploitation 404b and challenger 404c as described below. The selection model 102a and/or the prediction model 104a may be for performing automatic filter and prediction 412 of an unlabeled dataset.

In some embodiments disclosed herein, there are provided systems and methods for generating a sample of renewal policies for human workers, or oracles, to verify on a periodic basis (e.g. weekly), using an active learning-based selection model. The selection model may generally be for selecting data for training and developing a prediction model. Referring to FIG. 4A, in some embodiments of the present disclosure, a selection model 102a may comprise an exploration weighting 404a, wherein a greater relative exploration weighting 404a would result in the selection model 102a selecting a higher proportion of data for which a learning model or prediction model 104a lacks labeled data for. The selection model 102a may also comprise a challenger weighting 404c, which is related to the exploration weighting 404a but wherein a higher challenger weighting 404c would result in the selection model 102a selecting a higher proportion of random data to test the prediction model 104a. Further, the selection model 102a may comprise an exploitation weighting 404b, wherein a greater relative exploitation weighting 404b would result in the selection model 102a selecting a higher proportion of data which is likely to be either eligible or ineligible for a particular category of product or service, e.g. discounted rates on renewal.

The challenger weighting 404c provides reservation of a portion of randomly sampled renewal policies. This makes it possible to compare frequently the prediction model's 104a performance to random sampling. Therefore, at no additional computational cost, this provides a continuous monitoring strategy and thus minimize the risks of overfitting the prediction model. Overfitting may generally refer to where performance of a model is too closely tied to the specific data used to train it and where the model does not perform well with other or more generalized data. By using more random data resulting form the challenger weighting 404c, there is provided the prediction model 104a with a more robust training data set.

Appropriate emphasis on exploration, exploitation and challenger (through the exploration weighting 404a, the exploitation weighting 404b, and the challenger weighting 404c, respectively) may vary over time via the proposed computing systems and methods. For example, initially, the prediction model 104a may require emphasis on exploration to develop the prediction model 104a. Over time, the computing system and the prediction model 104a may shift emphasis more to exploitation and/or challenger by changing the exploration weighting 404a, the exploitation weighting 404b, and the challenger weighting 404c. The increase to the challenger weighting 404c provides a random verification function. This may coincide with increased availability of labeled data from a labeled dataset 408 for the prediction model 104a.

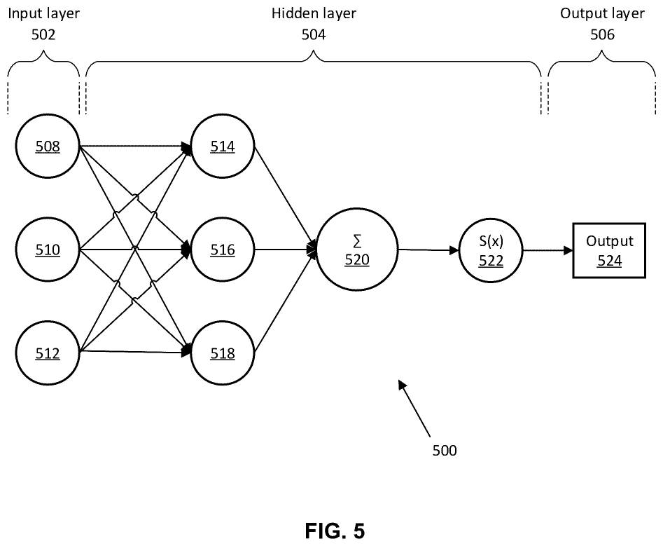

Embodiments of systems and methods disclosed herein may use any suitable methods for classification but may use a machine learning method such as random forest, which may combine results of a plurality of decision trees to reach a solution, instead of more computational and training intensive methods such as artificial neural networks (ANN). Referring to FIG. 5, a schematic diagram of an embodiment of an ANN 500 for performing calculations is illustrated. The ANN may comprise a number of neurons or nodes. The ANN 500 may comprise an input layer 502 having one or more input nodes 508, 510, 512, a hidden layer 504 comprising a plurality of intermediate nodes 514, 516, 518, 520, 522, and an output layer 506, having one or more output nodes 524. Additional nodes, input layers, hidden layers, and output layers may be envisaged as the ANN 500 is simplified for illustrative purposes.

In some embodiments disclosed herein, the input nodes 508, 510, 512 are configured for receiving task data inputs. The intermediate nodes 514, 516, 518 perform calculations wherein square matrices of numerical constants are weighted and multiplied with the inputs using matrix multiplication. The hidden layer 504 further comprises the intermediate node 520 for performing a summation function that combines the results of the matrix multiplication from intermediate nodes 514, 516, 518 and the intermediate node 522 for performing a sigmoid function used as an activation function to transform results from the intermediate node 520 into a required form for output node 524.

Referring to FIG. 4A, when a particular client policy is up for renewal, it is desirable to predict whether the policy is eligible or qualifies for a discounted or affinity rate. In environments without labeled data, or an unlabeled dataset 402, relating to these upcoming renewals, training of appropriate prediction models 104a is challenging.

Due to the availability of feedback in applications of embodiments disclosed herein, active learning may be used in combination with a prediction model 104a. The human or oracle 406 intervention may be used to label new examples and improve the classification accuracy of the prediction model 104a by providing a labeled dataset 408. Since human verification may be required due to policies, this may be conducive to their involvement with the selection model 102a.

Active learning comprises optimizing the accuracy of a model by iteratively labelling a set of selected file reviews. Active learning may be considered a sampling strategy that uses both classical sampling methods and model-based sampling strategies. With active learning, a proposed (prediction) model may evolve over time according to the outcome of the reviewed files, indicated by their associated labeling. For example, if after some reviews the prediction model 104a of FIG. 4A identifies that an age bracket appears riskier than expected, the prediction model 104a may readjust to flag more of those transactions or data elements for review.

FIG. 3 illustrates a relative performance of machine learning models using active learning for query selection as per aspects of the methods and systems disclosed herein relative to random selection as a function of accuracy over amount of labeled data.

Machine learning methods may require a significant amount of data to generate useful models. In many applications, while there is access to large amounts of data, much of the available data may be unlabeled, and labeling them may be time-consuming and/or expensive and/or unfeasible. To address this, machine learning methods may be used to identify more promising data subsets to improve model performance. A data point selected for inquiry regarding its label may be referred to as a query, and the entity providing the label for the queried data point may be referred to as an oracle. An oracle may be a human input on a user interface or on a computing application or computing device, an automated computing system having access to accurate information about the data, a database, a data repository, a data management server or system, and/or a software on a computing device or external web resource providing the label for the query.

Machine learning methods may be capable of achieving better performance if learning methods are involved in the process of selecting the data points it is trained on, such as in active learning methods. Active-learning based methods, as disclosed herein, may achieve improved performance by selecting data points that may be more useful for training, based on some form of i) uncertainty measure (for example, using the data points where the machine learning method is most uncertain about) or ii) some form of data representativeness (for example, using the data points that are good representatives of the data distribution).

Depending on the type of data to be considered, there are two main variations of active learning methods: stream-based and pool-based. In stream-based active learning, the learning method (e.g. a classifier), may have access to each unlabeled data point sequentially for a short period of time. The active learning method may determine whether to request a query or discard the request. In pool-based active learning, the learning method (e.g. a classifier) may have access to a pool of all unlabeled data. At each iteration, the method may query the label of an unlabeled data point from the oracle. In some embodiments disclosed herein, a pool-based active learning may be used in the selection model 102a. As a result, embodiments of the selection model 102a may be used to classify data from the unlabeled dataset 402 to provide the oracle 406 to generate a labeled dataset 408, which labeled data is provided to the learning model or prediction model 104a.

Methods using uncertainty sampling may query data points with higher uncertainty or where the prediction model does not have training with applicable labeled data. Upon observing a new point in an uncertain region, the prediction model may become more reliable about the neighboring subspace of the queried data point. The query strategy maintains an exploration and exploitation trade-off. In a classification task, entropy may be used as an uncertainty measure. However, motivated from support vector machines, uncertainty maybe considered through the decision boundary. For regression tasks, prediction variance may be a common uncertainty measure. Methods based on ensemble methods or neural networks may lack analytical form for prediction variance, so empirical variance of the prediction may be used instead.

Methods that focus on a single criteria to select a query may limit the active learning performance. Active learning methods may often be inhibited by a sampling bias. Therefore, an exploration and exploitation method with a large proportion of random sampling, especially during the early queries may be used in various implementations disclosed (e.g. see FIG. 4A). Adaptive strategy selection by connecting the selection problem to multi-arm bandit methods may be used. Unlabeled data points may be used as arms (or slot machines), or active learning strategies may be used as arms in the bandit problem. A meta-method for selecting a suitable unitary method to use at each time step may be used in order to maximize a specifically designed reward function (weighted accuracy computed on the points submitted to the oracle).

The modeling methodology of embodiments disclosed herein may be divided in two subsections: i) the prediction or base model 104a; ii) the selection or active learning model 102a.

### The Prediction Model 104a

When a policy is up for renewal, an example goal of the prediction model 104a is to predict whether this policy's eligibility to a discount is valid or not. That is to say that the response variable of the disclosed model is binary. The independent variables are policy and client characteristics. In example implementation, the model is primarily interested in the prediction capability and not in interpreting the model, the prediction model may comprise a method such as random forests further configured as described herein. The advantages of using random forests are that it has been proven to be a method of choice when prediction is more important than interpretation. Further, at no additional computational cost, uncertainty (or prediction variance) may be estimated with the empirical prediction variance. Indeed, a forest is composed of M trees, each tree produces a prediction probability ŷₘ so the empirical prediction variance may be computed by

$$\hat{v} ( x ) = \frac{1}{M - 1} {\sum }_{m = 1}^{M} {( {\hat{y}}_{m} - \overline{\hat{y}} )}^{2} ,$$

where \hat{y̅} is the average over the M trees (and the actual prediction probability for input x).

As stated before, methods using uncertainty sampling query data points with the highest uncertainty (i.e. with the highest û(x)). As human verification is generally required in a re-rating procedure, querying observations with highest predicted \hat{y̅} (i.e. maximizing the propensity) may be considered. However, these methods may be affected by sampling bias. Therefore, an exploration and exploitation method with a proportion of random sampling may be suitable (e.g. see FIG. 4A) for example implementations.

### The Selection Model 102a

The selection model 102a is a component of active learning used in embodiments disclosed herein and maintains a set of probability of picking each of the possible strategy and update them according to the reward received. In the present example context, a reward is querying a policy that requires a re-rate (i.e. the policy does not belong to the right affinity or discount).

Suppose that there is access to a set of K sampling strategies that provide an advice vector ξ of the size of the unlabeled set which contains the probability of querying each example.

Thus consider the following K=3 sampling strategies:
Random sampling (uniform)
Uncertainty sampling (from random forest)
Propensity sampling (from random)

Further, vector w∈[0, 1]^{K} indicates the probability of using each strategy and choose two update parameters K₀, K₁ which control the variation of w depending on the associated rewards received.

The parameter w is notable, as it provides control once the strategy is in production. Indeed, if ever there is a need of 100% of the sample to be selected at random, the vector w may be adjusted to have a probability equal to 1 for random sampling and 0 for the rest.

Pₘᵢₙ and Pₘₐₓ may be two threshold levels on the probabilities stored in w that may be used to reduce the time necessary to switch quickly from one current strategy (of index i with high wᵢ value) to another as the number of iterations increases. In order to maximize the reward r (which is equal to 1 if the queried file is successfully re-rated and 0 otherwise), the following evolving eligibility method may be used:
Data: Labeled set [symbol] and unlabeled set [symbol]
Result: Sequence of rewards [symbol] , final labelled set [symbol]
Initialization: Set initial probability of sampling each strategy

$${i}_{} = \frac{1}{K} ;$$

for [symbol] in {1, . . . , T} do
Pick a strategy [symbol] ∈{1, . . . , K} according to the distribution [symbol] ;
Sample the next point [symbol] for which we want a query according to [symbol] ;
Query the label [symbol] to the oracle;
Receive a reward [symbol] according to [symbol] ;
Update the sets: [symbol] +¹= [symbol] ∪( [symbol] , [symbol] ) and [symbol] +¹= [symbol] \( [symbol] , [symbol] );
Update the probabilities [symbol] according to the following heuristic:

$$if r = 1 then$$

$${i}_{} = min ( ( {𝒦}_{1} {w}_{i ,} {P}_{max} ) ;$$

$$else$$

$${i}_{} = max ( {𝒦}_{o} {w}_{i} , {P}_{min} ) ;$$

$$end$$

$$∀ j \neq i , w [ ( j ) ] = max ( min ( w [ ( j ) ] , {P}_{max ,} {P}_{min} ) :$$

$$= \frac{{\sum }_{t = 1}^{K} {w}_{t}}{}$$

Update the strategies using [symbol] ;

end

An active learning method for computer assisted evolving eligibility is described herein. Note that T may refer to as the sampling budget and may represent the maximum number of files that an underwriting team can review (e.g. 25 per week for example).

Following this method, the prediction model may be re-trained as frequently as the number of samples increases. That is to say that for each b batches of files labeled by the oracle, it is possible to frequently re-train the prediction model and continue to use the selection model.

Initially, each sampling strategy may have equal chance (⅓) of being selected. Hence, w=[⅓, ⅓, ⅓]. This vector is likely to evolve as more labeled data is collected following the above method. Also, parameters K₀, and K₁ above may be set at 0.8 and 1.2 respectively.

Pₘᵢₙ and Pₘₐₓ may be selected to be 0.2 and 0.8 respectively. The rationale for this selection is that as part of the active learning and for monitoring purpose to ensure each strategy would be sampled at a probability of at least 20% and no strategy would be theoretically selected more than 80% of the time.

FIG. 4B illustrates an active learning loop 450 illustrating the iterative nature of the process comprising a query step 452, an annotate step 454, an append step 456 and a train step 458. The query step 452 may comprise using an acquisition function to select examples from unlabeled data, the annotate step 454 may comprise using oracles or humans to annotate selected examples, the append step 456 may comprise adding newly labeled examples to training data, and the training step 458 may comprise training the prediction model based on labeled training data.

In some embodiments, some of the set of data may be excluded from consideration for a number of reasons to further improve efficiency of the selection model and/or the prediction model. For example, clients who are not eligible for a discounted or affinity group rate for other reasons than would be considered by the prediction model may be excluded from analysis. For example, clients or customer over a threshold age may be excluded (e.g. 65+). Further, clients or customers on employer groups, alumni (previously verified under other policies), membership lists, or VIP clients may be excluded. Further files may be sampled within a particular renewal window (e.g. 90-96 days).

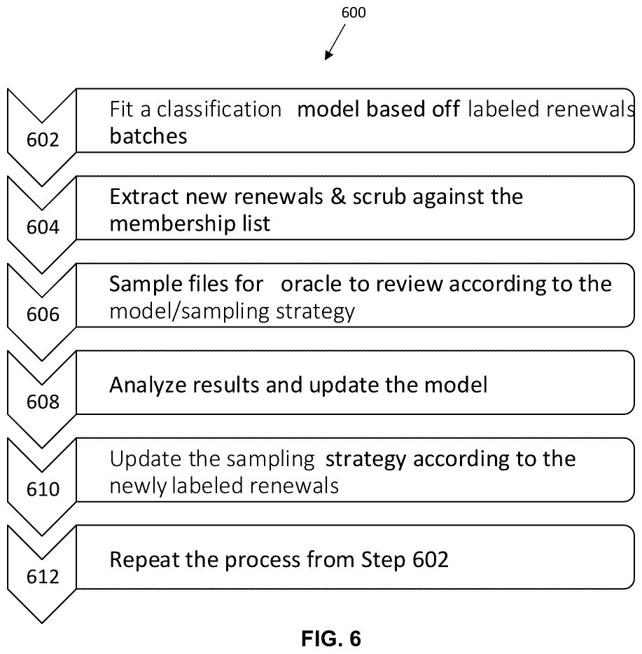

FIG. 6 illustrates example operations of a method 600 which may be performed by the selection model system 102 and/or the prediction model system 104 (e.g. as illustrated in FIGS. 1, 2 and 4A) according to some embodiments of the present disclosure. For example, a processor of a computing system (e.g., the processor 122 of the prediction model system 104 of FIG. 2 and/or the processor of the selection model system 102) may execute instructions to cause the computing systems to carry out the example method 600. The method 600 begins with fitting a classification or prediction model based off labeled renewal batch datasets (at step 602) by prediction model system 104. At step 604, the method may comprise extracting new renewals and scrub against membership lists by the selection model system 102 and/or the prediction model system 104. At step 606, the method may comprise sampling files for oracle to review according to a model/sampling strategy by the selection model system 102. At step 608, the method may comprise analyzing results and updating the model by the prediction model system 104. At step 610, the method may comprise updating the sampling strategy according to newly labeled renewals by the selection model system 102 and/or the prediction model system 104. At step 612, the process may be repeated from step 602.

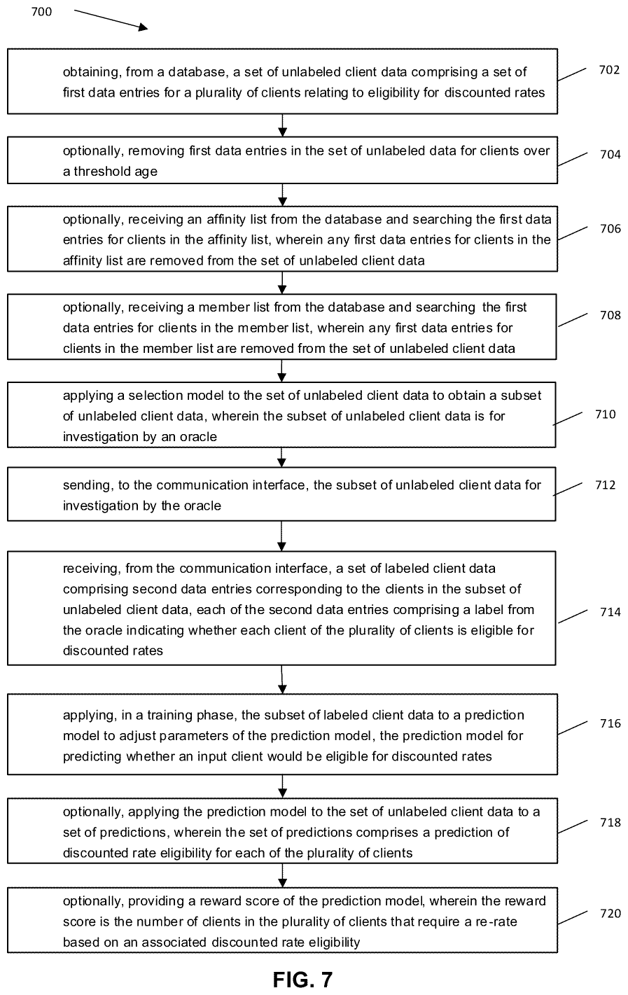

FIG. 7 illustrates steps of a method 700 which may be performed by the selection model system 102 and/or the prediction model system 104 according to some embodiments of the present disclosure. For example, a processor of a computing system (e.g., the processor 122 of the prediction model system 104 of FIG. 2 and/or the processor of the selection model system 102) may execute instructions to cause the computing systems to carry out the example method 700. The method 700 begins with obtaining, from a database, a set of unlabeled data comprising a set of first data entries for a plurality of clients relating to eligibility for discounted rates (at step 702) by the selection model system 102. At step 704, optionally, the method comprises removing first data entries in the set of unlabeled data for clients over a threshold age by the selection model system 102. At step 706, optionally, the method comprises receiving an affinity list from the database and searching the first data entries for clients in the affinity list, wherein any first data entries for clients in the affinity list are removed from the set of unlabeled data by the selection model system 102. At step 708, optionally, the method comprises receiving a member list from the database and searching the first data entries for clients in the member list, wherein any first data entries for clients in the member list are removed from the set of unlabeled data by the selection model system 102. At step 710, the method comprises applying a selection model 102a of the selection model system 102 to the set of unlabeled data to obtain a subset of unlabeled data, wherein the subset of unlabeled data is for investigation by an oracle. At step 712, the method may comprise sending, to the communication interface, the subset of unlabeled data for investigation by the oracle from the selection model system 102. At step 714, the method may comprise receiving, from the communication interface to selection model system 102 and/or the prediction model system 104, a set of labeled data comprising second data entries corresponding to the clients in the subset of unlabeled data, each of the second data entries comprising a label from the oracle indicating whether each client of the plurality of clients is eligible for discounted rates. At step 716, the method may comprise applying, in a training phase, the subset of labeled data to a prediction model 104a of the prediction model system 104 to adjust parameters of the prediction model, the prediction model for predicting whether an input client would be eligible for a particular category or type of product, service or resource, e.g. renewal or discounted rates for a product or service. At step 718, optionally, the method may comprise applying the prediction model 104a of the prediction model system 104 to the set of unlabeled data to a set of predictions, wherein the set of predictions comprises a prediction of eligibility for a particular category of service, resource, or product, e.g. discounted rate eligibility for each of the plurality of clients. At step 720, optionally, the method may comprise determining and providing a reward score of the prediction model 104a, which may be displayed on the user interface 130 of FIG. 2, being an interactive graphical user interface, by the prediction model system 104, wherein the reward score is the number of clients in the plurality of clients that require a re-rate based on an associated eligibility for the particular resource or service, e.g. discounted rate eligibility for subsequent interaction.

One or more currently preferred embodiments have been described by way of example. It will be apparent to persons skilled in the art that a number of variations and modifications can be made without departing from the scope of the disclosure as defined in the claims.

1. A computer implemented system comprising:
a communication interface;
a memory storing instructions;
one or more processors coupled to the communications interface and to the memory, the one or more processors configured to execute the instructions to perform operations to train a prediction model using active learning comprising:
obtaining, from a database, a set of unlabeled data comprising a set of first data entries for a plurality of clients relating to eligibility for discounted rates;
applying a selection model to the set of unlabeled data to obtain a subset of unlabeled data, wherein the subset of unlabeled data is for investigation by an oracle;
sending, to the communication interface, the subset of unlabeled data for investigation by the oracle;
receiving, from the communication interface, a set of labeled data comprising second data entries corresponding to the clients in the subset of unlabeled data, each of the second data entries comprising a label from the oracle indicating whether each client of the plurality of clients is eligible for discounted rates; and
applying, in a training phase of the prediction model, the subset of labeled data to the prediction model to adjust parameters of the prediction model, the prediction model for predicting whether an input client would be eligible for discounted rates.

2. The system of claim 1, wherein the selection model comprises an exploration weighting, wherein the exploration weighting is for determining a preference of selecting unlabeled data that the prediction model is not trained for.

3. The system of claim 2, wherein the selection model comprises a challenger weighting, wherein the challenger weighting is for determining a preference of randomly selecting unlabeled data.

4. The system of claim 1, wherein the selection model comprises an exploitation weighting, wherein the exploitation weighting is for determining a preference of selecting unlabeled data that is likely not eligible for discounted rates.

5. The system of claim 1, wherein the operations further comprise applying the prediction model to the set of unlabeled data to a set of predictions, wherein the set of predictions comprises a prediction of discounted rate eligibility for each of the plurality of clients.

6. The system of claim 5, wherein the operations further comprise providing a reward score of the prediction model, wherein the reward score is a number of clients in the plurality of clients that require a re-rate based on an associated discounted rate eligibility.

7. The system of claim 1, wherein the set of unlabeled data is for renewals within a renewal period.

8. The system of claim 1, wherein the operations further comprise removing first data entries in the set of unlabeled data for clients over a threshold age.

9. The system of claim 1, wherein the operations further comprise receiving an affinity list from the database and searching the first data entries for clients in the affinity list, wherein any first data entries for clients in the affinity list are removed from the set of unlabeled data.

10. The system of claim 1, wherein the operations further comprise receiving a member list from the database and searching the first data entries for clients in the member list, wherein any first data entries for clients in the member list are removed from the set of unlabeled data.

11. A computer implemented method comprising:
obtaining, from a database, a set of unlabeled data comprising a set of first data entries for a plurality of clients relating to eligibility for discounted rates;
applying a selection model to the set of unlabeled data to obtain a subset of unlabeled data, wherein the subset of unlabeled data is for investigation by an oracle;
sending, to a communication interface, the subset of unlabeled data for investigation by the oracle;
receiving, from the communication interface, a set of labeled data comprising second data entries corresponding to the clients in the subset of unlabeled data, each of the second data entries comprising a label from the oracle indicating whether each client of the plurality of clients is eligible for discounted rates; and
applying, in a training phase for training a prediction model using active learning, the subset of labeled data to the prediction model to adjust parameters of the prediction model, the prediction model for predicting whether an input client would be eligible for discounted rates.

12. The method of claim 11, wherein the selection model comprises an exploration weighting, wherein the exploration weighting is for determining a preference of selecting unlabeled data that the prediction model is not trained for.

13. The method of claim 12, wherein the selection model comprises a challenger weighting, wherein the challenger weighting is for determining a preference of randomly selecting unlabeled data.

14. The method of claim 11, wherein the selection model comprises an exploitation weighting, wherein the exploitation weighting is for determining a preference of selecting unlabeled data that is likely not eligible for discounted rates.

15. The method of claim 11 further comprising applying the prediction model to the set of unlabeled data to a set of predictions, wherein the set of predictions comprises a prediction of discounted rate eligibility for each of the plurality of clients.

16. The method of claim 15 further comprising providing a reward score of the prediction model, wherein the reward score is a number of clients in the plurality of clients that require a re-rate based on an associated discounted rate eligibility.

17. The method of claim 11, wherein the set of unlabeled data is for renewals within a renewal period.

18. The method of claim 11 further comprising removing first data entries in the set of unlabeled data for clients over a threshold age.

19. The method of claim 11 further comprising receiving an affinity list from the database and searching the first data entries for clients in the affinity list, wherein any first data entries for clients in the affinity list are removed from the set of unlabeled data.

20. The method of claim 11 further comprising receiving a member list from the database and searching the first data entries for clients in the member list, wherein any first data entries for clients in the member list are removed from the set of unlabeled data.
